(19) United States
(12) Patent Application Publication
(10) Pub. No.: US 2020/0111083 A1
(43) Pub. Date: Apr. 9, 2020

(54) PLATFORM FOR FACILITATING CONNECTIVITY OF SMART FIREARMS

(71) Applicant: Blocksafe Holdings, Inc., Cheyenne, WY (US)

(72) Inventor: Kevin Barnes, Acworth, GA (US)

(73) Assignee: Blocksafe Holdings, Inc., Cheyenne, WY (US)

(21) Appl. No.: 16/706,056

(22) Filed: Dec. 6, 2019

Related U.S. Application Data
(63) Continuation of application No. 16/118,910, filed on Aug. 31, 2018, now abandoned.
(60) Provisional application No. 62/552,959, filed on Aug. 31, 2017.

(51) Int. Cl. G06Q 20/36; H04L 9/06; G06Q 20/06

(52) U.S. Cl. CPC G06Q 20/3678; H04L 9/0637; G06Q 20/065; F41A 17/063; H04L 2209/56; G06Q 2220/00; H04L 2209/38

(57) ABSTRACT

A system comprises a programmable processor, one or more sensors in communication with the processor, and a memory in communication with the processor. The memory contains data and instructions executable by the processor to perform blockchain processing. The system also comprises a communications module in communication with the processor and with a network. The system is incorporated in a firearm.

### CROSS-REFERENCE TO RELATED APPLICATIONS

This application claims the benefit of U.S. Provisional Application Ser. No. 62/552,959, filed Aug. 31, 2017, the entire disclosure of which is incorporated by reference.

### BACKGROUND

Various types of firearms are available in the market, including handguns, long guns, shotguns, submachine guns, rifles, and carbines. Conventional firearms include mechanical systems (such as trigger guards) to provide safety to the firearms. However, the mechanical systems may fail leading to accidents.

Accordingly, smart firearms have been developed. These incorporate processing capability, computer memory storing program instructions, communication devices and a locking mechanism for the weapon. The processing capability of smart firearms provides increased security and safety. The smart firearms may be able to store usage data and environment data. Further, the smart firearms may be able to share the stored data with external systems. However, there are concerns related to securely and reliably connecting smart firearms with external computer networks, given this new processing and communications capability in smart firearms.

Accordingly, there is a need for methods, systems and platforms that enable secure and reliable connection of smart firearms amongst themselves and with computer networks.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 is an illustration of a platform consistent with various embodiments of the present disclosure.

FIG. 2 is a computing system of a firearm, in accordance with some embodiments.

FIG. 3 illustrates a smart firearm network, in accordance with some embodiments.

FIG. 4 is a flowchart of a method for using cryptocurrency along with smart firearms, in accordance with some embodiments.

FIG. 5 is a block diagram of a computing device for implementing the methods disclosed herein, in accordance with some embodiments.

### DETAILED DESCRIPTION

According to some aspects, the present disclosure provides a platform for facilitating connectivity of smart firearms. The platform uses blockchain based technologies for securing various transactions associated with internet of things (IoT) processing.

According to some aspects, the present disclosure provides a method for using cryptocurrency along with smart firearms.

According to some aspects, the present disclosure provides a smart firearm capable of using cryptocurrency. The smart firearm is equipped with one or more sensors such as environmental sensors and/or firearm usage sensors. Further, the smart firearm may also be equipped with processing, storage and network capabilities. A memory of the smart firearm may contain a distributed ledger (e.g., a blockchain) and a cryptographic wallet. Initially, the user of the firearm may load a starting amount of cryptocurrency into the wallet. The cryptocurrency may then be used by the smart firearm to conduct transactions.

According to some aspects, the present disclosure describes software that may be embedded in smart firearms, where the software may be configured to implement a distributed ledger and a cryptocurrency wallet. The smart firearm may send data from onboard hardware, such as sensors, to the software. The software may then encrypt the data using a quantum generated string and store it on a local copy of the ledger. Thereafter, the smart firearm may connect to a distributed network securely to propagate the data stored on the local ledger to other ‘nodes’ (similarly integrated into respective smart firearms) to synchronize to the ledger. Smart firearms with the software installed may be considered nodes in the larger distributed ledger system.

According to further aspects, upon achieving consensus that the data is encrypted, the smart firearm may be rewarded with cryptocurrency tokens. For example, at a given time, 100 million tokens may exist in total in the distributed ledger system. Nodes may be rewarded (or earn) “tokens” for performing consensus work. Further, the rewards may also be received by the smart firearm for storing data from a network device (called proof of storage) and for retrieving data (proof of delivery). The rewarded token may be stored in the secured digital wallet. The wallet may be managed with the credentials of a private cryptographic key.

According to further aspects, the present disclosure provides an encrypted end-to-end messaging system that enables smart firearms to communicate with other smart firearms sharing the same private key. The encrypted private mesh networking protocol may be used for notifications or system commands.

According to some aspects, the present disclosure provides a smart firearm network which may be named “Blocksafe smartgun network”. Further, the present disclosure enables firearm innovators to bring Internet of Things (IoT) firearm products and technology to market faster with secure full-stack IoT distributed ledger technology.

Both the foregoing and the description that follows provide examples and are explanatory only. Accordingly, the foregoing and the following description should not be considered to be restrictive. Features or variations may be provided in addition to those set forth herein. For example, embodiments may be directed to various feature combinations and sub-combinations described in the description herein.

As a preliminary matter, it will readily be understood by one having ordinary skill in the relevant art that the present disclosure has broad utility and application. As should be understood, any embodiment may incorporate only one or a plurality of the above disclosed aspects of the disclosure and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing herefrom, which scope is to be defined by the claims and the equivalents thereof. It is not intended that the scope of patent protection be defined by reading into any claim a limitation found herein that does not explicitly appear in the claim itself.

Further, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences while still falling within the scope of the present disclosure. Accordingly, it is intended that the scope of patent protection is to be defined by the issued claim(s) rather than the description set forth herein.

Additionally, each term used herein refers to that which an ordinary artisan would understand such term to mean based on the contextual use of such a term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present disclosure includes many aspects and features. Moreover, while many aspects and features relate to, and are described in, the context of firearms, embodiments of the present disclosure are not limited to use only in this context.

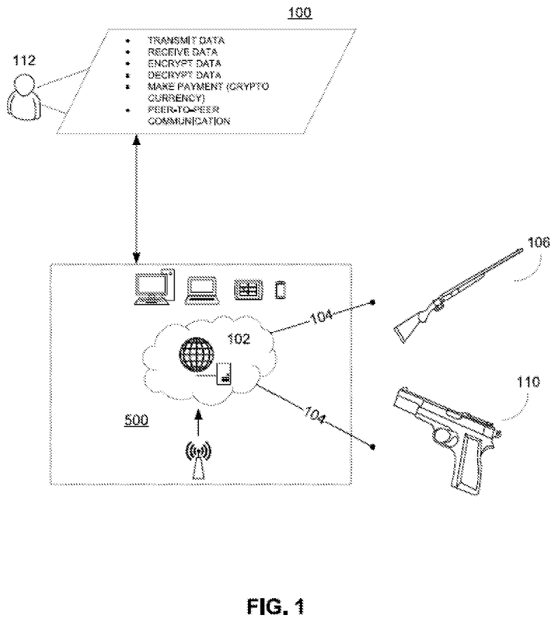

FIG. 1 is an illustration of an online platform 100 consistent with various embodiments of the present disclosure. By way of non-limiting example, the online platform 100 for facilitating connectivity of smart firearms may be hosted on a centralized server 102, such as, for example, a server that is a component of a cloud computing service. The centralized server 102 may communicate with other network entities, such as, for example, shotgun 106 and/or other smart firearms 110 over a communication network 104, such as, but not limited to, the Internet. Further, users of the platform may include relevant parties such as one or more of firearm users, firearm manufacturers, firearm sellers and administrators. Accordingly, the smart firearms operated by the one or more relevant parties may be in communication with the platform. The platform 100 may employ blockchain based technologies for securing various transactions associated with internet of things processing.

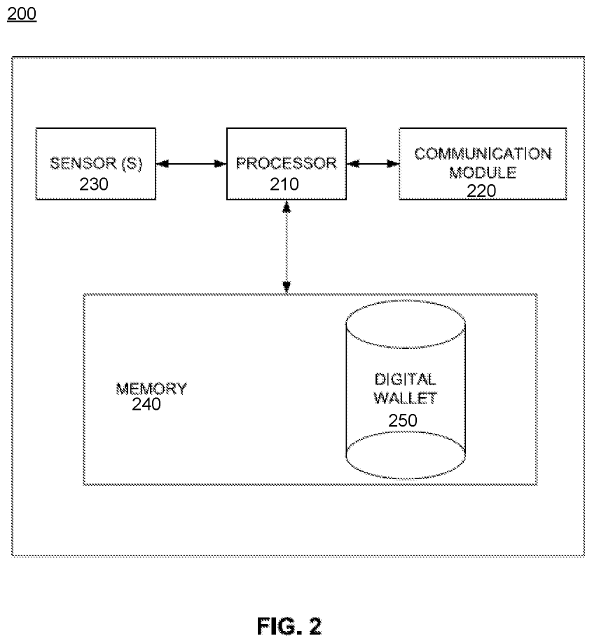

A user 112, such as the one or more relevant parties, may access platform 100 through a software application. The software application may be compatible with a computing system of a smart firearm, as shown in FIG. 2.

FIG. 2 is a computing system 200 of a smart firearm, in accordance with some embodiments. The smart firearm is equipped with one or more sensors 230, which may include environmental sensors (such as temperature sensors and humidity sensors) and usage sensors (such as a sensor to detect when trigger is pulled or a mechanical safety is engaged or disengaged) and/or geographical location sensors.

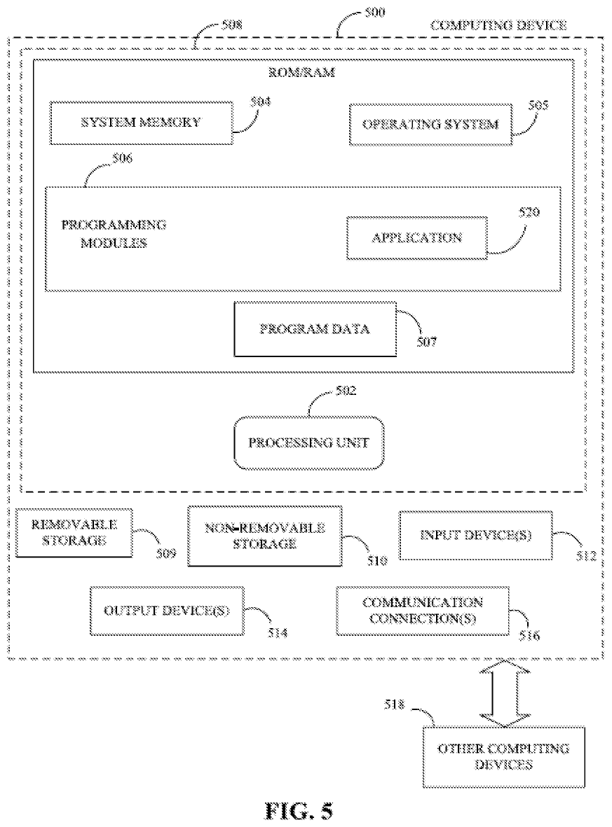

Further, the firearm may be equipped with a processor 210, a communications module 220, and a memory 240. The processor 210 may be used to execute software instructions which may be obtained from the memory 240. The communication module 220 may provide network capabilities to the firearm. Further, the memory 240 may contain a distributed ledger and a digital wallet (cryptocurrency wallet) 250. The digital wallet 250 may be configured to store cryptocurrency, such as, but not limited to TRIG Token, Bitcoin, Ether, Litecoin, Monero, XRP, MaidSafeCoin, Lisk, and Storjcoin X FIG. 5 shows the computing system of a smart firearm in further detail, and will be further discussed below.

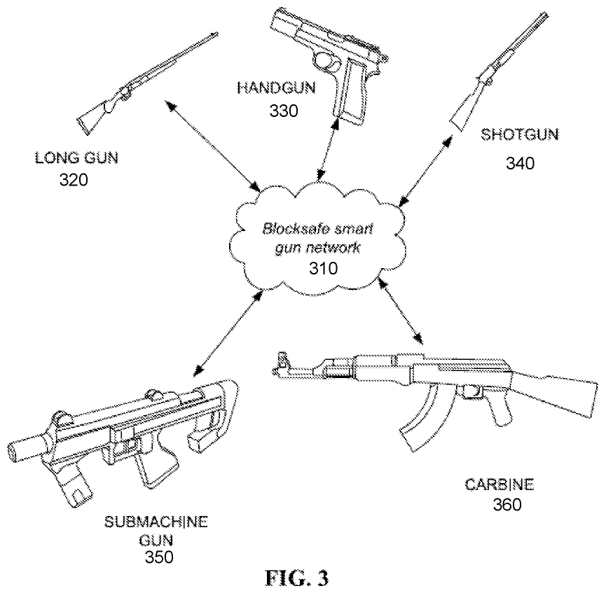

FIG. 3 illustrates a smart firearm network, in accordance with some embodiments. Multiple smart firearms may connect to the smartgun network. The multiple smart firearms may include, but are not limited to, handguns, long guns, shotguns, submachine guns, assault rifles and carbines. Each of the multiple smart firearms may include an embodiment of the computing system of FIG. 2. Further, the smart firearm network may include the platform 100. The platform 100 enables implementation of a blockchain-based transaction processing system for transactions between the platform 100 and the smart firearms and/or for transactions among the smart firearms.

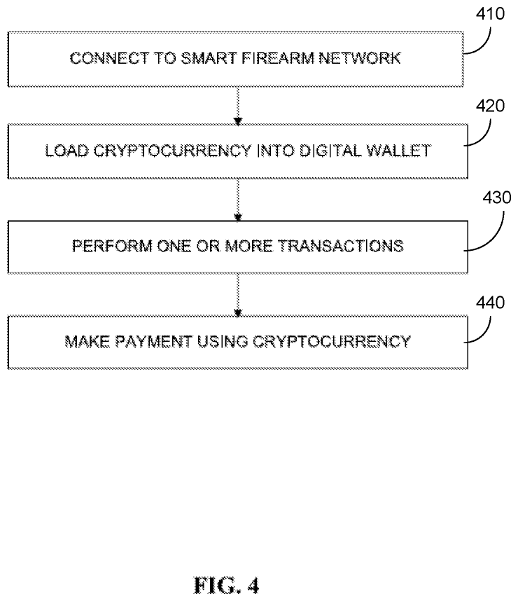

FIG. 4 is a flowchart of a method for using cryptocurrency along with smart firearms, in accordance with some embodiments. At 410, one or more smart firearms may connect to the smart firearm network of FIG. 3. The communication modules of the respective smart firearms may be used to connect to and communicate with the smart firearm network using any protocol know to persons of ordinary skill in the art. Thereafter, at 420 a user of a smart firearm may load a starting amount of cryptocurrency into the digital wallet of the smart firearm.

At 430, the smart firearm may start using the cryptocurrency in order to carry out one or more transactions facilitated by the platform 100. The one or more transactions may include transmitting data previously collected, downloading data, communicating with other firearms (in peer-to-peer communication, for example), encrypting data to be transmitted, and decrypting received data. For each transaction, the smart firearm may pay from the digital wallet (440).

The smart firearm may maintain a distributed ledger in its memory and may thus synchronize transaction data with other nodes (or other firearms) containing the distributed ledger in order to implement a blockchain-based transaction processing system.

Further, the smart firearms may receive rewards (i.e. cryptocurrency) for participation in transactions facilitated by the platform 100. Similarly, other such services, providing encryption, decryption or providing consensus of a finding (for example, data is encrypted properly etc.) may be also be performed and associated rewards collected and stored in the digital wallet of respective firearms.

In some embodiments, the smart firearms may earn a token when they complete a consensus task, e.g., mining the chain for token(s). This can keep the network self-sustainable. Further, even if a smart firearm is not in use, it may accumulate tokens received from performing consensus tasks as requested from a peer node (e.g., another smart firearm). Accordingly, such tokens may be stored locally in a storage module of the smart firearm or in a decentralized application's wallet—thus creating a machine to machine economy.

FIG. 5 is a block diagram of a computing device 500. This represents a more detailed description of the system of FIG. 2. Any suitable combination of hardware, software, or firmware may be used to implement this memory storage and processing unit. For example, the storage device and the processing device may be implemented with computing device 500 or any of other computing devices 518, in combination with computing device 500. The aforementioned system, device, and processors are examples and other systems, devices, and processors may comprise the aforementioned storage device and processing device, consistent with embodiments of the disclosure.

With reference to FIG. 5, a system consistent with an embodiment of the disclosure may include a computing device or cloud service, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination thereof. System memory 504 may include operating system 505, one or more programming modules 506, and may include program data 507. Operating system 505, for example, may be suitable for controlling computing device 500's operation. In one embodiment, programming modules 506 may include an encryption module, a transaction module and a communication module. Furthermore, embodiments of the disclosure may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, flash drives, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer-readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet.

Communication connection 516 is one example of communication media.

Communication media may typically be embodied by computer readable instructions, data structures, program modules, or other data in a modulated data signal, such as a carrier wave or other transport mechanism, and includes any information delivery media. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g., application 520 such as a media player) may perform processes including, for example, one or more stages of methods, algorithms, systems, applications, servers, databases as described above. The aforementioned process is an example, and processing unit 502 may perform other processes.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a non-transitory computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A system comprising:
a programmable processor;
one or more sensors in communication with the processor;
a memory in communication with the processor, the memory containing instructions executable by the processor to perform blockchain processing and further containing data; and
a communications module in communication with the processor and with a network,
wherein the system is incorporated in a firearm.

2. The system of claim 1, wherein the data contained in the memory comprises a digital wallet capable of storing cryptocurrency.

3. The system of claim 1, wherein the one or more sensors comprise a fingerprint sensor.

4. The system of claim 1, wherein the one or more sensors comprise a temperature sensor.

5. The system of claim 1, wherein the one or more sensors comprise a humidity sensor.

6. The system of claim 1, wherein the one or more sensors comprise a geographical location sensor.

7. The system of claim 1, wherein the one or more sensors comprise a firearm usage sensor.

8. The system of claim 1, wherein the communications module is in peer-to-peer communication with a second communications module in a respective second firearm.

9. The system of claim 1, wherein the communications module is in communication with a centralized server via the network.

10. The system of claim 1, wherein the data stored in the memory comprises a blockchain.

11. The system of claim 10, wherein the blockchain processing comprises storing a transaction in the blockchain.

12. The system of claim 11, wherein the transaction comprises encrypting or decrypting information.

13. The system of claim 11, wherein the transaction comprises transmitting or receiving information.

14. The system of claim 11, wherein the blockchain processing comprises making a payment associated with the transaction, using cryptocurrency stored in the digital wallet.

15. The system of claim 1, wherein the blockchain processing comprises currency mining.

16. A process, performed by a first firearm, comprising:
connecting to a network that comprises at least a server and a second firearm;
storing a blockchain for which the first firearm is a node;
storing cryptocurrency in a digital wallet in the first firearm;
performing a transaction; and
making a payment associated with the transaction, using the cryptocurrency.

17. The process of claim 16, further comprising:
storing a record of the transaction in the blockchain.

18. The process of claim 16, further comprising:
performing currency mining.
